(19) United States
(12) Patent Application Publication
(10) Pub. No.: US 2026/0351047 A1
(43) Pub. Date: Nov. 5, 2026

(54) INFORMATION PROCESSING SYSTEM FOR OUTPUTTING ABNORMAL BEHAVIOR DETERMINATION REASON, CONTROL METHOD FOR INFORMATION PROCESSING SYSTEM, AND STORAGE MEDIUM

(71) Applicant: CANON KABUSHIKI KAISHA, Tokyo (JP)

(72) Inventor: KEN SWYSEN, Tokyo (JP)

(21) Appl. No.: 19/665,657

(22) Filed: May 1, 2026

(30) Foreign Application Priority Data
May 2, 2025 (JP) 2025-076853

(51) Int. Cl. G06V 40/20; G06V 20/52; G08B 13/196

(52) U.S. Cl. CPC G06V 40/20; G06V 20/52; G08B 13/19613

(57) ABSTRACT

An information processing system acquires behavior data concerning behavior of an image capturing target included in an image acquired by an image capturing unit, determines whether the behavior of the image capturing target included in the behavior data is normal or abnormal, and outputs a behavior type and an abnormal behavior determination reason corresponding to the image capturing target the behavior of which has been determined to be abnormal. The information processing system performs output processing for the behavior type prior to output processing for the abnormal behavior determination reason.

### BACKGROUND

### Field of the Technology

The present disclosure relates to an information processing system for outputting an abnormal behavior determination reason, a control method for an information processing system, and a storage medium.

### Description of the Related Art

In recent years, the demand for security maintenance in, for example, airports, stations, commercial facilities, and smart cities has been increasing, and an abnormal behavior detection system which detects abnormal behavior with use of an image (moving image or still image) captured by an installed monitoring camera has become widespread. In terms of utilizing, for security maintenance, the abnormal behavior of an image-captured person (target for image capturing such as a person) extracted from an image captured by the monitoring camera, not only system responsiveness, which has been conventionally prioritized, but also system explainability is becoming increasingly important. This arises from the fact that, as the background of the necessity of taking into consideration the feelings of an image-captured person suspected of abnormal behavior or the growing awareness of, for example, preventing wrongful arrest, there is growing recognition of the responsibility of not only the security maintenance management side but also the system development side. Accordingly, there is a demand to provide an abnormal behavior detection system with responsiveness and explainability.

Japanese Patent Laid-Open No. 2021-97285 describes, as a conventional method concerning detection of abnormal behavior, a method of determining that, in a case where an image-captured person has behaved differently than usual, there is abnormal behavior. The method described in Japanese Patent Laid-Open No. 2021-97285 has responsiveness because, no matter what type of abnormal behavior the abnormal behavior of the image-captured person is, the method classifies such abnormal behavior as abnormity insofar as it is unusual and, moreover, the method employs, as a detection method, a lightweight and fast machine learning method. However, this method has difficulty specifically explaining what type of behavior the abnormal behavior of the image-captured person is and thus lacks explainability.

Moreover, Japanese Patent Laid-Open No. 2022-107137 describes, as another conventional method concerning detection of abnormal behavior, a method of using a detector that detects basic actions and a rule that defines behavior targeted for detection by a combination of basic actions. The method described in Japanese Patent Laid-Open No. 2022-107137 has responsiveness because, in a case where the abnormal behavior of the image-captured person has met the rule, the method is able to determine the type of the behavior with high likelihood and, moreover, the method employs, as a detection method, a relatively lightweight and fast machine learning method. However, in a case where the image-captured person has taken unexpected abnormal behavior that is not preliminarily defined in the rule, this method has difficulty detecting such abnormal behavior, and it can hardly be said that this method is equipped with explainability with respect to actual use cases assuming various abnormal behaviors.

### SUMMARY

The present disclosure is directed to providing a contrivance concerning detection of abnormal behavior in which both responsiveness and explainability are satisfied in a more favorable fashion.

According to an aspect of the present disclosure, an information processing system includes at least one processor, and at least one memory having stored therein instructions which, when executed by the at least one processor, cause the information processing system at least to: acquire behavior data concerning behavior of an image capturing target included in an image acquired by an image capturing unit; determine whether the behavior of the image capturing target included in the behavior data is normal or abnormal; and output a behavior type and an abnormal behavior determination reason corresponding to the image capturing target the behavior of which has been determined to be abnormal, wherein output processing for the behavior type is performed prior to output processing for the abnormal behavior determination reason.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a hardware configuration of an abnormal behavior detection system according to a first embodiment.

FIG. 2 is a diagram illustrating an example of an outline configuration of the abnormal behavior detection system according to the first embodiment.

FIG. 3 is a flowchart illustrating an example of processing performed by the abnormal behavior detection system according to the first embodiment.

FIG. 4 is a diagram illustrating an example of a user interface (UI) of the abnormal behavior detection system according to the first embodiment.

FIG. 5 is a diagram illustrating an example of an outline configuration of an abnormal behavior detection system according to a second embodiment.

FIG. 6 is a flowchart illustrating an example of processing performed by the abnormal behavior detection system according to the second embodiment.

FIG. 7 is a diagram illustrating an example of a captured image.

FIG. 8 is a flowchart illustrating an example of processing performed by an abnormal behavior detection system according to a third embodiment.

FIG. 9 is a diagram illustrating an example of a UI of the abnormal behavior detection system according to the third embodiment.

### DESCRIPTION OF THE EMBODIMENTS

Various embodiments, features, and aspects of the present disclosure will be described in detail below with reference to the drawings.

Furthermore, in the present specification and drawings, constituent elements having the substantially same functional configuration are assigned the respective same reference characters, so that any duplicated description is omitted.

### First Embodiment

As an example of an information processing system to which a technique corresponding to a first embodiment of the present disclosure is applied, an abnormal behavior detection system is described.

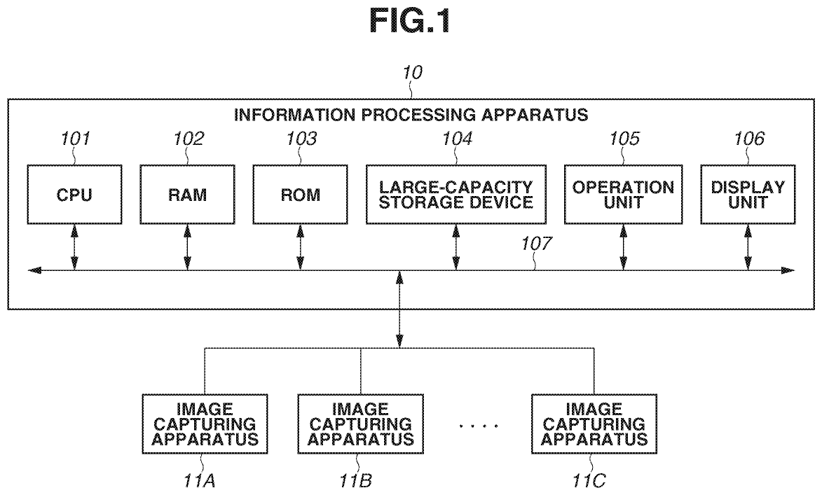

FIG. 1 is a diagram illustrating an example of a hardware configuration of the abnormal behavior detection system according to the first embodiment. The abnormal behavior detection system (information processing system) according to the first embodiment includes an information processing apparatus 10 and a plurality of image capturing apparatuses 11. In the example illustrated in FIG. 1, the abnormal behavior detection system (information processing system) according to the first embodiment includes image capturing apparatuses 11A, 11B, . . . , and 11C.

The information processing apparatus 10 includes a central processing unit (CPU) 101, a random access memory (RAM) 102, a read-only memory (ROM) 103, and a large-capacity storage device 104. Moreover, the information processing apparatus 10 further includes an operation unit 105 and a display unit 106.

The CPU 101 performs various processing operations using computer programs and data stored in the RAM 102 and the ROM 103. Accordingly, the CPU 101 performs operation control of the entire information processing apparatus 10 and performs or controls various processing operations.

The RAM 102 has an area for storing computer programs and data loaded from the ROM 103 or the large-capacity storage device 104. Moreover, the RAM 102 can include an area for storing pieces of data received from the above-mentioned plurality of image capturing apparatuses 11. Moreover, the RAM 102 has a work area that the CPU 101 uses to perform various processing operations. In this way, the RAM 102 is able to provide various areas as appropriate.

In the ROM 103, for example, setting data about the information processing apparatus 10, computer programs or data related to start-up, and computer programs or data related to basic operations are stored.

The large-capacity storage device 104 is a storage region for storing various pieces of data and is implemented by, for example, a hard disk drive device. In the large-capacity storage device 104, an operating system (OS) and computer programs and data for causing the CPU 101 to perform or control various processing operations that are described below as those which the information processing apparatus 10 performs are stored. Pieces of data that are stored in the large-capacity storage device 104 can include, for example, image sequence data captured by each image capturing apparatus 11 and model data related to abnormal behavior detection described below. Computer programs and data that are stored in the large-capacity storage device 104 are loaded onto the RAM 102 as appropriate according to control performed by the CPU 101 and are then used as targets for processing performed by the CPU 101.

The operation unit 105 is implemented by a user interface such as a keyboard, a mouse, or a touch panel, and is able to be operated by the user to input various instructions to the CPU 101.

The display unit 106 includes a screen such as a liquid crystal screen or a touch panel screen and is able to display a processing result obtained by the CPU 101 as, for example, an image or characters to present the processing result to the user. Furthermore, the display unit 106 can be implemented by a projection device such as a projector for projecting an image or characters.

Each of the CPU 101, the RAM 102, the ROM 103, the large-capacity storage device 104, the operation unit 105, and the display unit 106 is connected to a system bus 107. Furthermore, the configuration illustrated in FIG. 1 is merely an example and should not be construed to limit the hardware configuration of the information processing apparatus 10.

The information processing apparatus 10 can be implemented by a computer device such as a personal computer (PC), a smartphone, or a tablet terminal device each including a set of input/output equipment.

The image capturing apparatuses 11 illustrated in FIG. 1 as the image capturing apparatuses 11A, 11B, . . . , and 11C are described. Each image capturing apparatus 11 is connected to the information processing apparatus 10. Moreover, the information processing apparatus 10 receives images captured by the respective image capturing apparatuses 11. The information processing apparatus 10 refers to times appended to images captured by the respective image capturing apparatuses 11 and is able to, after receiving the respective images from the plurality of image capturing apparatuses 11, synchronize the images received from the respective image capturing apparatuses 11 with each other.

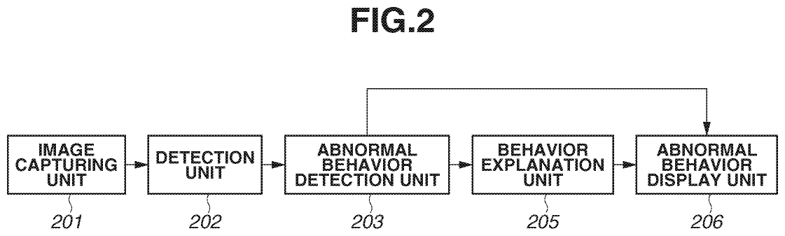

An example of an outline configuration of the abnormal behavior detection system according to the first embodiment is described with reference to FIG. 2. The abnormal behavior detection system according to the first embodiment includes an image capturing unit 201, a detection unit 202, an abnormal behavior detection unit 203, a behavior explanation unit 205, and an abnormal behavior display unit 206.

The image capturing unit 201 acquires an image. The image that is acquired by the image capturing unit 201 can be an image captured by, for example, a network camera, an image stored in a storage device such as a hard disk, or an image received via a network such as the Internet. The image acquired by the image capturing unit 201 is sent to the detection unit 202.

The detection unit 202 receives, as an input, the acquired image and detects an image-captured person (image capturing target) included in the received image. The detection unit 202 generates behavior data based on the image of the detected image-captured person and sends the generated behavior data to the abnormal behavior detection unit 203. Furthermore, the detection unit 202 is equivalent to an example of an acquisition unit that acquires behavior data concerning behavior of an image capturing target included in an image.

The abnormal behavior detection unit 203 detects abnormal behavior of the image-captured person based on the behavior data and then outputs a result of the detection of abnormal behavior. The result of the detection of abnormal behavior includes a binary determination result indicating any one of normality or abnormality and is sent to the behavior explanation unit 205. Moreover, when determining that the behavior of the image-captured person is abnormal behavior, the abnormal behavior detection unit 203 sends an abnormal behavior detection log to the abnormal behavior display unit 206. Furthermore, the abnormal behavior detection unit 203 is equivalent to a determination unit which determines whether behavior of the image capturing target included in the behavior data is normal or abnormal.

The behavior explanation unit 205 outputs a generated text including a behavior type and an abnormal behavior determination reason about the image capturing target with use of the result of the detection of abnormal behavior of the image-captured person by the abnormal behavior detection unit 203 and the behavior data generated by the detection unit 202. Furthermore, the behavior explanation unit 205 is equivalent to an output unit that outputs a behavior type and an abnormal behavior determination reason about the image capturing target the behavior of which has been determined to be abnormal.

When it has been determined by the abnormal behavior detection unit 203 that there is abnormal behavior, the abnormal behavior display unit 206 displays the abnormal behavior detection log sent from the abnormal behavior detection unit 203. Moreover, when the behavior type of the abnormal behavior has been acquired by the behavior explanation unit 205 and when the abnormal behavior determination reason has been acquired by the behavior explanation unit 205, the abnormal behavior display unit 206 updates the behavior type or the abnormal behavior determination reason in the corresponding abnormal behavior detection log based on the acquired value.

According to the above-described outline configuration of the abnormal behavior detection system according to the first embodiment, with regard to an optional image-captured person the image of whom has been captured, at a point of time when the behavior of the image-captured person has been determined to be abnormal, the abnormal behavior detection system is able to notify the user of the presence of abnormality and thus has responsiveness. Moreover, the abnormal behavior detection system is able to preferentially acquire the behavior type of the image-captured person and is, therefore, able to promptly achieve the explainability for the abnormal behavior. Additionally, the abnormal behavior detection system is able to acquire the abnormal behavior determination reason and is, therefore, able to further enhance explainability. Moreover, because it is possible to cause the behavior explanation unit 205 to perform processing only in a case where the abnormal behavior detection unit 203 has detected abnormality, the abnormal behavior detection system is able to reduce the consumption of a system operation resource and is, therefore, suitable for the present use case.

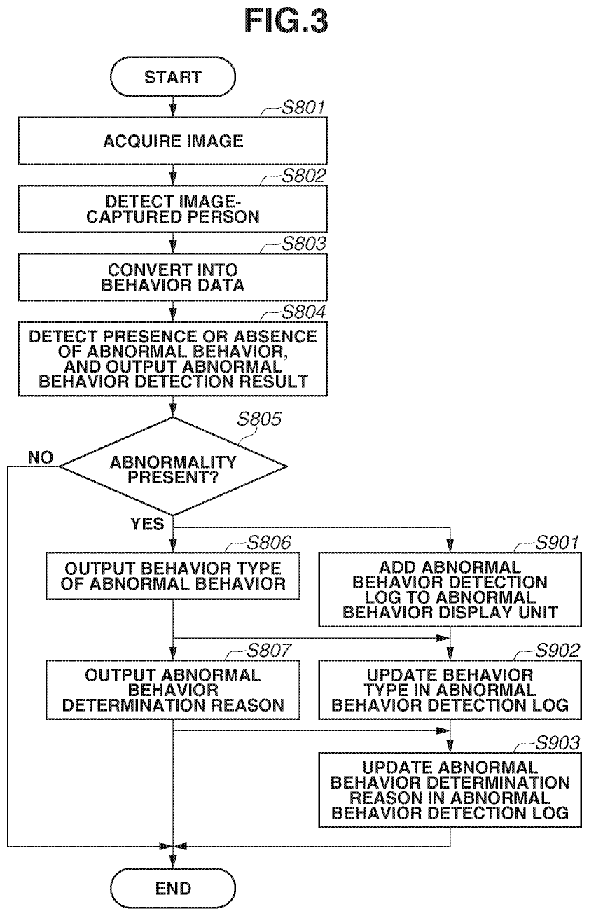

An example of processing performed by the abnormal behavior detection system according to the first embodiment is described with reference to FIG. 3.

In step S801, the image capturing unit 201 acquires an image or an image sequence. Furthermore, the format of data that is acquired by the image capturing unit 201 at this time is not particularly limited. Moreover, the number of pixels concerning image acquisition, a frame rate, and other parameters related to image quality can be optionally set.

In step S802, the detection unit 202 performs detection of an image-captured person with respect to the image acquired in step S801. The method of detection of an image-captured person included in the image is, for example, a method using a neural network, but is not limited to this method and can be an optionally applicable method. Moreover, the number of image-captured persons to be detected can be optional, and, in a case where a plurality of image-captured persons is included in the image, the method can include processing for division into a batch number unit that is processable at a subsequent stage. Besides, the presence or absence of tracking processing for a detected image-captured person can be optionally applied.

In step S803, the detection unit 202 converts a result of detection of an image-captured person in step S802 into behavior data to be passed to the abnormal behavior detection unit 203.

The behavior data is any one of or a combination of some or all of coordinate information about a visible detection frame containing a visible region of the image-captured person (coordinate information in the image), a sequence of the coordinate information, an image or image sequence of the image-captured person, or a posture estimation result or posture estimation result sequence of the image-captured person. The posture estimation result can be any one of or a combination of a joint point position estimation result of the image-captured person or the orientation of the image-captured person. Each of the coordinate information sequence, the image sequence, and the posture estimation result sequence can be data that is based on a series of consecutive image frames that are acquired by the image capturing unit 201, or can be data that is based on an image group obtained by optionally thinning out consecutive image frames. Moreover, each of the coordinate information sequence, the image sequence, and the posture estimation result sequence can include numerical data that is calculated as a result of processing, such as acquisition of a difference between frames included in the sequence.

Examples of the behavior data to be acquired include a first image-captured person who walks and a second image-captured person who runs in a zigzag, and the behavior data is assumed to be a sequence of center point coordinates of a rectangle containing each image-captured person. If the sequence of center point coordinates of the first image-captured person is plotted, the speed or the direction vector behaves relatively steadily. On the other hand, if the sequence of center point coordinates of the second image-captured person is plotted, the speed is supposed to be higher than that of the first image-captured person and the temporal change in the direction vector is assumed to become larger than that of the first image-captured person.

In step S804, the abnormal behavior detection unit 203 receives the behavior data as an input and outputs an abnormal behavior detection result. The abnormal behavior detection result includes a binary determination result indicating normality or abnormality, a determination likelihood thereof, and an intermediate parameter. The method of calculating the abnormality binary determination and determination likelihood may be selected from, a method that is based on machine learning and that performs learning with a normal system set as training data and, in a case where there is an input that falls outside the training data, regards the input as abnormal. Specific examples thereof include a method which, in a mapping space obtained by plotting an origin and a training data group obtained in a one-class support vector machine (SVM) method using support vector machines, uses distances of behavior data from the origin, performs binary determination based on each distance being high or low relative to the threshold, and calculating the determination likelihood according to each distance. Naturally, this method is merely an example, and the specific method is not limited to this method and can be an optional applicable method.

The intermediate parameter, which is included in the abnormal behavior detection result, is supplementarily described. It is desirable that the behavior data be converted into multidimensional vector data with a given fixed dimension number that can be handled by the abnormal behavior detection unit 203. Conversion from the behavior data into the multidimensional vector data is performed by, for example, an autoencoder. The autoencoder is a neural network aimed at causing high-dimensional data, such as an input image applied in the first embodiment, to once pass through a low-dimensional intermediate layer and then obtaining an image that approximates the input image as closely as possible at an output layer. It is supposed that a parameter at the intermediate layer used at this time is passed to the abnormal behavior detection unit 203. With regard to conversion from other behavior data into multidimensional vector data, for example, in a case where the behavior data is a sequence with no fixed length, conversion using a method obtained by combining a recurrent neural network (RNN) and an autoencoder is applied. Using the RNN enables, while setting an input as fixed length data per one frame, causing the intermediate layer to learn temporal features.

According to the above-described method, with respect to the abnormal behavior detection unit 203 trained with training data only for persons walking straight, each of the pieces of behavior data, mentioned above as an example, about the first image-captured person who walks and the second image-captured person who runs in a zigzag is converted into multidimensional vector data serving as an intermediate parameter. At this time, the first image-captured person is performing behavior close to the training data and the multidimensional vector data about the first image-captured person is plotted to a point farther from the origin in a mapping space. On the other hand, the second image-captured person is performing behavior which does not exist in the training data and the multidimensional vector data about the second image-captured person is plotted to a point closer to the origin in the mapping space. According to the distance of the plotted point from the origin in the mapping space, the abnormal behavior detection unit 203 outputs an “abnormality absent” determination result with respect to the behavior data about the first image-captured person, and outputs an “abnormality present” determination result with respect to the behavior data about the second image-captured person. In a case where an abnormality determination likelihood is output along with the abnormality determination result, the abnormality determination likelihood is determined according to the distance of the plotted point from the origin in the mapping space.

In step S805, the abnormal behavior detection unit 203 determines whether the abnormality binary determination result is an “abnormality present” determination result.

If, in step S805, it is determined that the abnormality binary determination result is an “abnormality present” determination result (YES in step S805), the abnormal behavior detection unit 203 advances the processing to step S806 and step S901. In this case, the behavior explanation unit 205, which follows the abnormal behavior detection unit 203, receives the behavior data and the abnormal behavior detection result. Furthermore, the details of processing operations in step S901, step S902, and step S903 are described below.

On the other hand, if, in step S805, it is determined that the abnormality binary determination result is an “abnormality absent” determination result (NO in step S805), the abnormal behavior detection unit 203 ends the series of processing operations illustrated in FIG. 3.

In step S806, the behavior explanation unit 205 receives, as inputs, the behavior data and the abnormal behavior detection result and then outputs generated text. The generated text includes a behavior type, which represents what the behavior of the image-captured person is.

First, the behavior explanation unit 205 preferentially performs outputting of the behavior type. Next, in step S807, the behavior explanation unit 205 outputs generated text that includes an abnormal behavior determination reason, which explains why the behavior has been determined to be abnormal.

Examples of the method that can be used by the behavior explanation unit 205 include a model that is based on a large language model. With regard to the generated text to be output, it is desirable that the above-mentioned output order be controlled by a preliminarily input prompt. Moreover, the format of the generated text can be controlled to be JavaScript Object Notation (JSON) but is not limited to this format and can be an optional applicable format.

As examples of providing input to the behavior explanation unit 205 and the behavior type acquisition method, first, a case in which an image sequence of the image-captured person included in the behavior data is used as an input can be considered. A method called Video CLIP (V-CLIP), which is based on a neural network model trained with pair data including large-scale images and natural languages called Contrastive Language Image Pre-training (CLIP) and which has been expanded to an image sequence, is known. With respect to such a model, additional learning is performed with a data set including, as a pair, a person image sequence accompanied by various normal or abnormal behaviors and a behavior type thereof, so that, with respect to a person image sequence accompanied by an input given behavior, it becomes possible to achieve a model capable of outputting a behavior type thereof in natural language.

Moreover, as another example, there is a large language model that is multidimensional vector data obtained by converting, by the above-mentioned autoencoder, a sequence of center point coordinates of a rectangle containing an image-captured person as an input. Learning is performed with data sets each including, as a pair, multidimensional vector data acquired from a large quantity of behavior records and a behavior type thereof, so that, after converting behavior data about an optional image-captured person into multidimensional vector data, it becomes possible to cause a model to achieve the capability of inferring a behavior type. The above-mentioned CLIP is also a neural network model that is based on a Transformer, and the Transformer is suitable for a variable-length input and is, therefore, suitable for processing of a sequence input.

Output processing for the abnormal behavior determination reason which the behavior explanation unit 205 performs is supplementarily described. As a first example, the case of explaining, as the abnormal behavior determination reason, in what way the behavior data that is based on the input abnormal behavior is abnormal with respect to behavior data that is based on a preliminarily learned given normal behavior is considered.

For example, the case of explaining, based on the above-mentioned pieces of behavior data about the first image-captured person who walks and the second image-captured person who runs in a zigzag, a process of behavior type estimation with respect to, particularly, the behavior data about the second image-captured person is described. In this case, it is possible to explain a process of behavior type estimation that is based on rationale, such as “the speed of the behavior concerned is X times higher than the average speed of a normal behavior,” “the behavior concerned includes Y-times changes in direction at the time of movement with a higher frequency than the average change in direction of a normal behavior,” and “accordingly, it is estimated that the image-captured person is performing behavior of ‘running in a zigzag.’”

To enable such outputting, it is desirable that the output of the behavior explanation unit 205 be controlled by a prompt being preliminarily input to the behavior explanation unit 205. The prompt is one of texts to be given to a large language model, and includes, particularly, information for controlling the content or format of text to be generated and output. In the above-mentioned example, it is supposed that a prompt such as “With regard to one piece of behavior data about an image-captured person to be input, first, output a maximum-likelihood behavior type representing the behavior. Next, explain the behavior type determination reason thereof along with one or more reasons.” is given. Additionally, it is also possible to specify the details of a reason for explaining behavior. In this case, it is desirable that a prompt such as “Output the behavior type determination reason based on, out of the input behavior data about an image-captured person, the posture, speed, and direction thereof and changes of them or an object worn on the image-captured person.” be given.

The output order in generated text is supplementarily described. The time required for full outputting of a large language model may be frequently several seconds to several minutes depending on an operation environment, and, on the other hand, the large language model also has a feature capable of performing gradational outputting. Therefore, there is a great advantage in outputting, in advance, information concerning abnormal behavior of high importance on security maintenance and informing the user of the information.

First, the behavior explanation unit 205 outputs the behavior type as first priority. This is because presenting information about the behavior type facilitates determining the degree of importance of the abnormal behavior. Next, the behavior explanation unit 205 outputs the abnormal behavior determination reason, thus increasing the explainability of the abnormal behavior detection system. A case where the abnormal behavior determination reason is used when an image-captured person the behavior of whom has been determined to be abnormal and a security maintenance personnel negotiate with each other is assumed or a case where the abnormal behavior determination reason is used for an abnormal behavior detection log report is assumed.

The behavior type that is included in generated text can be controlled by a prompt in such a manner that a behavior type that has been determined by the behavior explanation unit 205 to be a maximum-likelihood behavior type from a list of behavior types to be assumed is output. Because applying such control enables handling a behavior type as a category variable, an advantageous effect that increases the convenience of the system is expected.

Moreover, the generated text can include a statement for speaking to an image-captured person who has shown abnormal behavior. However, in the first embodiment, it is assumed that, prior to processing for outputting a statement for speaking, the output processing for the behavior type is prioritized. Moreover, the behavior explanation unit 205 can preliminarily receive, as inputs, a plurality of pieces of communication destination information, and the generated text can include a list of notification destinations that are estimated to be appropriate as notification destinations about abnormal behavior extracted from the plurality of pieces of communication destination information. However, in the first embodiment, it is assumed that, prior to processing for outputting the list of notification destinations, the output processing for the behavior type is prioritized.

Because the output processing that the behavior explanation unit 205 performs may involve the use of a large system operation resource, such a situation as to omit part of the generation processing is conceivable. Specific examples include an example of using the behavior explanation unit 205 to output only the behavior type. In this case, because the generation processing for the abnormal behavior determination reason can be omitted, it is possible to save a system operation resource. Such switching control for the output processing can be performed based on monitoring of a system operational status such as memory usage or throughput, but the first embodiment is not limited to this example.

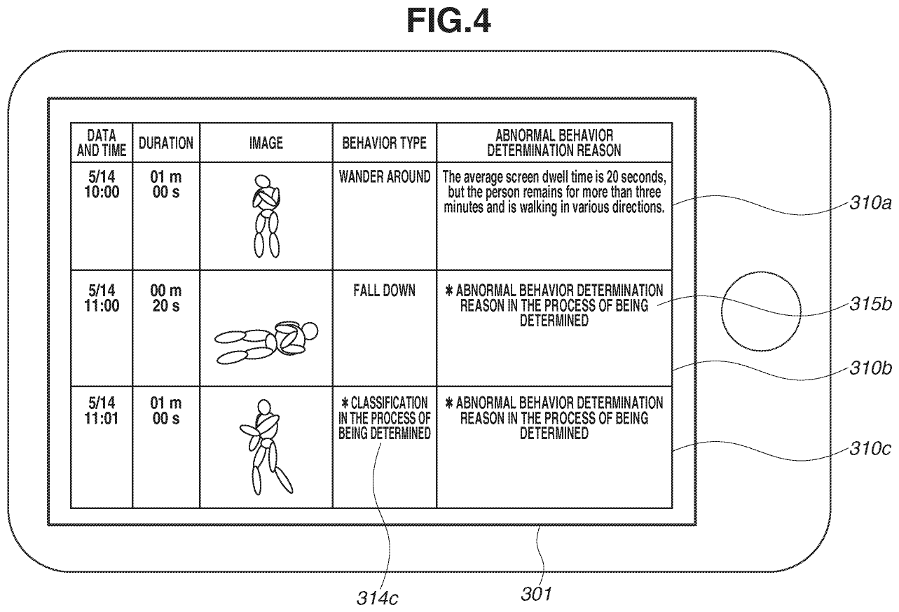

Processing operations related to control of a user interface (UI) included in the series of processing operations illustrated in FIG. 3 are described. FIG. 4 is a diagram illustrating an example of a UI that is displayed by the abnormal behavior display unit 206 of the abnormal behavior detection system according to the first embodiment.

In step S901, after abnormal behavior has been detected by the abnormal behavior detection unit 203, the abnormal behavior display unit 206 adds, to an abnormal behavior display unit UI 301, an abnormal behavior detection log that is based on a result of detection of abnormal behavior. In the example illustrated in FIG. 4, abnormal behavior detection logs 310a, 310b, and 310c are added. The abnormal behavior detection log can include, for example, various items such as time of acquisition of behavior data in which abnormality has been detected, a duration time of a sequence included in behavior data in a case where the behavior data includes the sequence, an image included in behavior data, a behavior type, and an abnormal behavior determination reason, but is not limited to this example and can also include an optional item.

In step S902, in a case where the acquisition of a behavior type has been completed by the behavior explanation unit 205 with respect to the abnormal behavior detection log, the abnormal behavior display unit 206 updates the value of a behavior type in the abnormal behavior detection log with the behavior type acquired by the behavior explanation unit 205.

In step S903, in a case where the acquisition of an abnormal behavior determination reason has been completed by the behavior explanation unit 205 with respect to the abnormal behavior detection log, the abnormal behavior display unit 206 updates the value of an abnormal behavior determination reason in the abnormal behavior detection log with the abnormal behavior determination reason acquired by the behavior explanation unit 205.

For example, in the example illustrated in FIG. 4, with regard to the abnormal behavior detection log 310a, the values of the behavior type and the abnormal behavior determination reason are currently updated with the behavior type and the abnormal behavior determination reason acquired by the behavior explanation unit 205.

Moreover, as another example, with regard to the abnormal behavior detection log 310b, while the acquisition of the behavior type has been completed, the acquisition of the abnormal behavior determination reason has not yet been completed. Therefore, with regard to the abnormal behavior detection log 310b, on the item of the abnormal behavior determination reason, a message 315b, which indicates that the acquisition of the abnormal behavior determination reason has not yet been completed, is displayed as the value thereof.

Moreover, as another example, with regard to the abnormal behavior detection log 310c, both the acquisition of the behavior type and the acquisition of the abnormal behavior determination reason have not yet been completed. Therefore, with regard to the abnormal behavior detection log 310c, on the item of the behavior type, a message 314c, which indicates that the acquisition of the behavior type has not yet been completed, is displayed as the value thereof. Moreover, with regard to the abnormal behavior detection log 310c, on the item of the abnormal behavior determination reason, a message indicating that the acquisition of the abnormal behavior determination reason has not yet been completed is displayed as the value thereof.

As described above, according to the abnormal behavior detection system in the first embodiment, it is possible to determine, with regard to an optional image-captured person, whether the behavior of the image-captured person is abnormal, identify a behavior type of the image-captured person, and then notify the user of a result of identification of the behavior type. Moreover, the abnormal behavior detection unit 203 of the abnormal behavior detection system according to the first embodiment employs a method of binary determination about normality or abnormality and, therefore, has a high detection performance and responsiveness. Then, with regard to behavior data in which abnormality has been detected, it is possible to preferentially acquire a behavior type by the behavior explanation unit 205 and notify the user of the acquired behavior type via the abnormal behavior display unit 206, so that an advantageous effect which increases the responsiveness and explainability of the system can be expected.

### Second Embodiment

An abnormal behavior detection system, which is an example of an information processing system to which the technique according to a second embodiment of the present disclosure is applied, is described. Furthermore, the hardware configuration of the abnormal behavior detection system according to the second embodiment is substantially similar to that in the above-described first embodiment and, therefore, the detailed description thereof is omitted here.

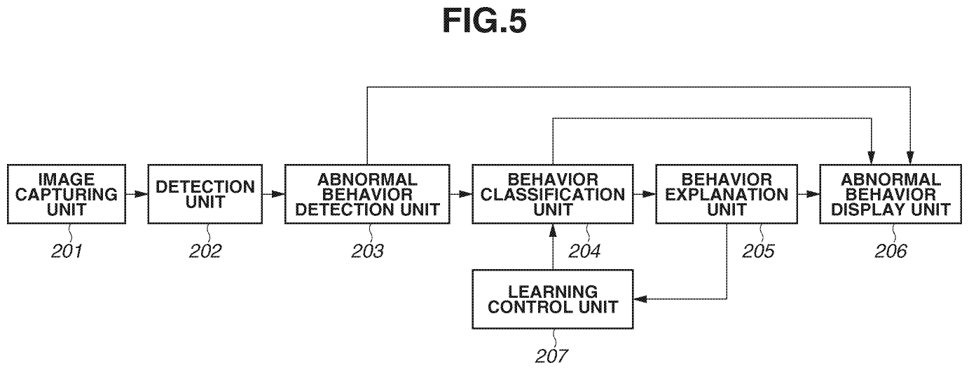

An example of an outline configuration of the abnormal behavior detection system according to the second embodiment is described with reference to FIG. 5. The abnormal behavior detection system according to the second embodiment includes an image capturing unit 201, a detection unit 202, an abnormal behavior detection unit 203, a behavior classification unit 204, a behavior explanation unit 205, an abnormal behavior display unit 206, and a learning control unit 207. Furthermore, the image capturing unit 201, the detection unit 202, the abnormal behavior detection unit 203, the behavior explanation unit 205, and the abnormal behavior display unit 206 are substantially similar to those in the above-described first embodiment and, therefore, the detailed description thereof is omitted here.

The behavior classification unit 204 outputs a behavior classification result including a behavior type of the image-captured person with use of a result of detection of abnormal behavior and behavior data. The behavior classification result includes an estimated likelihood of the behavior type. The behavior classification unit 204 sends the behavior classification result to the behavior explanation unit 205.

The behavior explanation unit 205 performs processing in a case where the estimated likelihood of the behavior type included in the behavior classification result that the behavior classification unit 204 outputs is greater than or equal to a predetermined value, and thus outputs generated text including the behavior type of the image-captured person and the abnormal behavior determination reason with use of the behavior data and the abnormal behavior detection result.

The learning control unit 207 generates additional training data based on behavior data when it is determined by the behavior classification unit 204 that additional training is required and on the behavior type included in the generated text output by the behavior explanation unit 205, and performs additional training of the behavior classification unit 204 with use of the additional training data.

On this occasion, the learning control unit 207 can perform generation of additional training data and additional training of the behavior classification unit 204 while targeting behavior data in which an abnormality determination likelihood that is output along with a result of abnormality determination of behavior of the image-captured person by the abnormal behavior detection unit 203 exceeds a preliminarily set predetermined value.

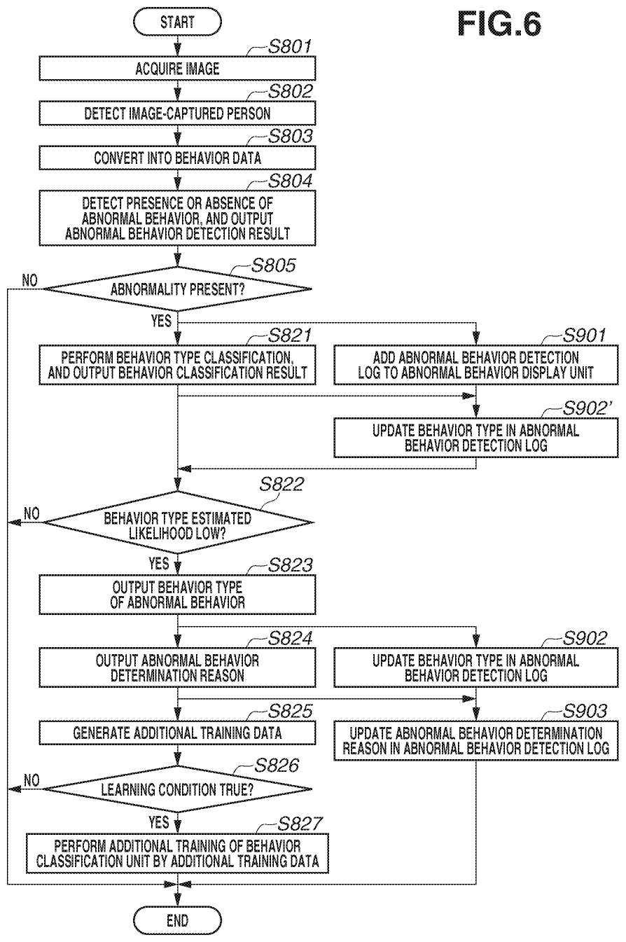

An example of processing performed by the abnormal behavior detection system according to the second embodiment is described with reference to FIG. 6. Furthermore, out of the series of processing operations illustrated in FIG. 6, processing operations substantially similar to the processing operations described above with reference to FIG. 3 in the first embodiment are omitted from detailed description here.

In step S805, the abnormal behavior detection unit 203 determines whether the abnormality binary determination result is an “abnormality present” determination result.

If it is determined that the abnormality binary determination result is an “abnormality present” determination result (YES in step S805), the abnormal behavior detection unit 203 sends behavior data and a result of detection of abnormal behavior to the behavior classification unit 204 and then advances the processing to step S821 and step S901.

On the other hand, if it is determined that the abnormality binary determination result is an “abnormality absent” determination result (NO in step S805), the abnormal behavior detection unit 203 ends the series of processing operations illustrated in FIG. 6.

In step S821, the behavior classification unit 204 receives, as inputs, behavior data and an abnormal behavior detection result and then outputs a behavior classification result based on the behavior data and the abnormal behavior detection result. The behavior classification result includes a behavior type that represents what the behavior of the image-captured person included in the input is (to which of a preliminarily defined plurality of candidates the type of behavior serving as a target corresponds) and an estimated likelihood thereof. Examples of the method of behavior classification include a method that is based on a convolutional neural network (CNN) and that outputs a maximum-likelihood behavior type label out of behavior type labels obtained by learning and also calculates an estimated likelihood based on the corresponding behavior type label likelihood. Examples of inputs that the behavior classification unit 204 uses include an image of the image-captured person or multidimensional vector data included in the abnormal behavior detection result.

In step S902′, the abnormal behavior display unit 206 receives outputting of the behavior type by the behavior classification unit 204, and thus updates, based on the received behavior type, a behavior type in the abnormal behavior detection log.

In step S822, the behavior classification unit 204 determines whether the behavior type estimated likelihood is less than or equal to a predetermined value.

If it is determined that the behavior type estimated likelihood is less than or equal to the predetermined value (YES in step S822), the behavior classification unit 204 sends the behavior data and the result of detection of abnormal behavior to the behavior explanation unit 205 and then advances the processing to step S823.

On the other hand, if it is determined that the behavior type estimated likelihood is not less than or equal to the predetermined value (NO in step S822), the behavior classification unit 204 ends the series of processing operations illustrated in FIG. 6.

In step S823, the behavior explanation unit 205 outputs generated text based on the received behavior data and the received result of detection of abnormal behavior.

Examples of the method of determining the predetermined value that is used for the determination to be performed in step S822 include a method that sets, as the predetermined value, a threshold value that yields the best evaluation value with respect to preliminarily retained evaluation data. Examples of the evaluation value that the behavior classification unit 204 uses include the F1 score that is obtained with use of a true behavior type and an estimated behavior type.

In the above-mentioned evaluation, the behavior classification unit 204 outputs estimation candidates, each of which is composed of {behavior type: likelihood}. The behavior classification unit 204 identifies, among the estimation candidates, an estimation candidate having a maximum likelihood. If the maximum likelihood exceeds the threshold value, the behavior classification unit 204 employs, as the estimated behavior type, the behavior type indicated by the estimation candidate. On the other hand, in a case where, in all of the estimated candidates, the likelihood thereof is less than or equal to the threshold value, the behavior classification unit 204 determines that the estimated behavior type is “abnormality absent.” As a specific example, if the threshold value is 0.5 and the estimated candidate by the behavior classification unit 204 is {walk: 0.6, run: 0.4}, the estimated behavior type that the behavior classification unit 204 outputs becomes “walk” and the likelihood thereof becomes “0.6.” On the other hand, if the threshold value is 0.5 and the estimated candidate by the behavior classification unit 204 is {walk: 0.3, run: 0.25, wander around: 0.25, stop: 0.2}, the estimated behavior type that the behavior classification unit 204 outputs becomes “abnormality absent” and the likelihood thereof also becomes “0.”

The F1 score is calculated based on the following relational expression:

F1 score=2×precision×recall/(precision+recall).

In the above-mentioned relational expression, the “precision” represents the proportion of cases in which the true behavior type matches the estimated behavior type among all of the pieces of data. Moreover, the “recall” represents the proportion of cases in which the true behavior type matches the estimated behavior type among pieces of data the estimated behavior type of which is “abnormality absent.” Because, if the threshold value is varied, the F1 score also varies, it is desirable that the threshold value that yields the best F1 score be applied as the above-mentioned predetermined value.

The generated text that the behavior explanation unit 205 outputs in steps S823 and S824 includes a behavior type that represents what the behavior of the image-captured person included in the behavior classification result is and an abnormal behavior determination reason that explains why the behavior has been determined to be abnormal. In a processing operation in step S823, first, the behavior explanation unit 205 preferentially performs outputting of the behavior type, and, next, in step S824, the behavior explanation unit 205 performs outputting of the abnormal behavior determination reason.

The abnormal behavior display unit 206 receives outputting of the behavior type and the abnormal behavior determination reason by the behavior explanation unit 205. In step S902, the abnormal behavior display unit 206 updates a behavior type in the abnormal behavior detection log, and, in step S903, the abnormal behavior display unit 206 updates the abnormal behavior determination reason in the abnormal behavior detection log.

In a case where the behavior type and the abnormal behavior determination reason have been output by the behavior explanation unit 205, in step S825, the learning control unit 207 receives behavior data obtained when the behavior explanation unit 205 has performed processing and thus generates additional training data based on the received behavior data. The additional training data is composed of behavior data and a behavior type that has been output by the behavior explanation unit 205.

In step S826, the learning control unit 207 determines whether a learning condition is satisfied.

If, in step S826, it is determined that the learning condition is satisfied (YES in step S826), the learning control unit 207 advances the processing to step S827.

On the other hand, if, in step S826, it is determined that the learning condition is not satisfied (NO in step S826), the learning control unit 207 ends the series of processing operations illustrated in FIG. 6.

In step S827, the learning control unit 207 performs additional training of the behavior classification unit 204 by the additional training data generated in step S825.

Because it is supposed that training of the behavior classification unit 204 is processing that is relatively large in a system operation resource, it is desirable that the learning condition be preliminarily set to control the frequency of learning execution.

Examples of the learning condition include a condition such as “if a given number of pieces of generated additional training data have been accumulated.” Evaluation processing (not illustrated) can be included in the learning condition after the completion of training of the behavior classification unit 204, and processing for switching the behavior classification unit 204 through the evaluation processing can also be included in the learning condition.

As described above, according to the abnormal behavior detection system in the second embodiment, at a point in time when, with regard to an optional image-captured person, determining whether the behavior of the image-captured person is abnormal, the abnormal behavior detection system is able to notify the user of the presence of abnormality and thus has responsiveness. Moreover, because the abnormal behavior detection system is able to acquire a behavior type of the image-captured person by the behavior classification unit 204, which is lighter and faster than the behavior explanation unit 205, the explainability for abnormal behavior is promptly achieved. Additionally, because, with regard to a case of abnormal behavior the classification of which is hard even for the behavior classification unit 204, the behavior type and the abnormal behavior determination reason are acquired by the behavior explanation unit 205, the explainability is increased. Moreover, the behavior classification unit 204 performs processing only when the abnormal behavior detection unit 203 has detected the presence of abnormality, and the behavior explanation unit 205 performs processing only when the behavior classification unit 204 has determined that the behavior type estimated likelihood is greater than or equal to a predetermined value. Therefore, the abnormal behavior detection system is able to reduce the consumption of a system operation resource and is, therefore, suitable for the present use case. Moreover, because additional training of the behavior classification unit 204 is autonomously performed with use of the behavior type output by the behavior explanation unit 205, it is possible to increase the detection performance.

### Third Embodiment

An abnormal behavior detection system, which is an example of an information processing system to which the technique according to a third embodiment of the present disclosure is applied, is described. Furthermore, the hardware configuration of the abnormal behavior detection system according to the third embodiment is substantially similar to that in the above-described first embodiment and, therefore, the detailed description thereof is omitted here.

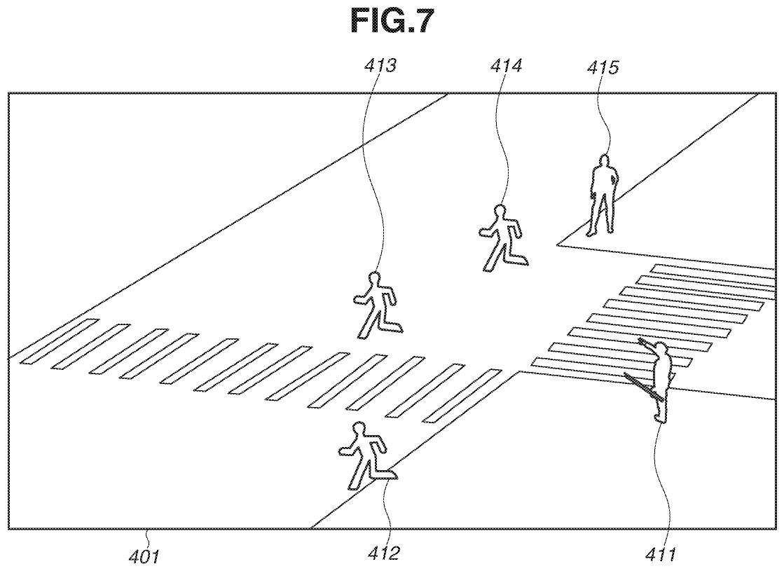

FIG. 7 illustrates an example of a captured image that is captured by the image capturing unit 201 according to the third embodiment. In the example illustrated in FIG. 7, images of a plurality of image-captured persons 411 to 415 are shown in a captured image 401, and these image-captured persons are detected by the detection unit 202. Moreover, for example, the image-captured person 411, who is walking while carrying a long object, and the image-captured persons 412 to 414, who are running, are detected as image-captured persons accompanied by abnormal behavior by the abnormal behavior detection unit 203.

In a case where, as in the example illustrated in FIG. 7, abnormal behaviors of a plurality of image-captured persons included in a captured image obtained by a single image capturing unit are detected, an incident involving a plurality of persons is anticipated. In the case of the configuration and operation described above in the first embodiment, with respect to each of the individual image-captured persons accompanied by abnormal behavior, the behavior explanation unit 205 individually performs processing. On the other hand, with regard to an incident involving a plurality of persons, further prompt handling may be demanded from the viewpoint of security maintenance, so that the behavior explanation unit 205 may also be requested to output the explanation of an incident as soon as possible. Therefore, in the third embodiment, an example of a case where, instead of the behavior explanation unit 205 individually performing processing for every image-captured person to aid the interpretation of an incident, the behavior explanation unit 205 performs processing while targeting the entirety of an image or image sequence acquired by the image capturing unit 201 is described.

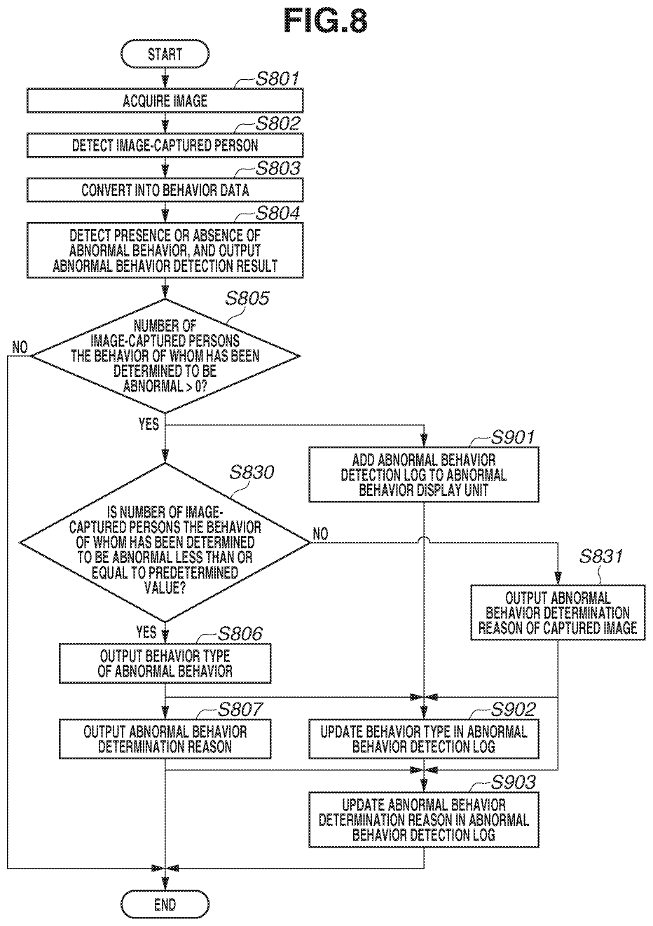

An example of processing performed by the abnormal behavior detection system according to the third embodiment is described with reference to FIG. 8. Furthermore, out of the series of processing operations illustrated in FIG. 8, processing operations substantially similar to the processing operations described above with reference to FIG. 3 in the first embodiment are omitted from detailed description here.

In step S804, the abnormal behavior detection unit 203 receives behavior data as an input and outputs an abnormal behavior detection result. The abnormal behavior detection result includes a binary determination result indicating normality or abnormality and a determination likelihood thereof.

Moreover, in this embodiment, at step S805, the abnormal behavior detection unit 203 counts the number of image-captured persons the behavior of whom has been determined to be abnormal within a given fixed time. If the number is greater than zero, the abnormal behavior detection unit 203 proceeds to step S830. Then, in step S830, the abnormal behavior detection unit 203 determines whether the number of image-captured persons the behavior of whom has been determined to be abnormal is less than or equal to a previously set predetermined value.

If, in step S830, it is determined that the number of image-captured persons the behavior of whom has been determined to be abnormal is less than or equal to the predetermined value (YES in step S830), the abnormal behavior detection unit 203 advances the processing to step S806. In this case, a processing operation similar to that described above in the first embodiment is performed. Thus, in step S806, the behavior explanation unit 205 receives, as inputs, the behavior data and the abnormal behavior detection result and then outputs generated text. Moreover, in step S807, the behavior explanation unit 205 outputs the abnormal behavior determination reason. Furthermore, in the following description, for the purpose of convenience, processing operations in step S806 and step S807 are also referred to as “first behavior explanation processing.” In other words, the first behavior explanation processing is equivalent to processing for, while individually targeting each image-captured person included in the image, outputting generated text including a behavior type and an abnormal behavior determination reason regarding the behavior of the image-captured person.

On the other hand, if, in step S830, it is determined that the number of image-captured persons the behavior of whom has been determined to be abnormal exceeds the predetermined value (NO in step S830), the abnormal behavior detection unit 203 advances the processing to step S831.

In step S831, the behavior explanation unit 205 receives, as inputs, the behavior data, the abnormal behavior detection result, and an image or image sequence acquired by the image capturing unit 201 and thus performs processing for outputting generated text including an abnormal behavior determination reason of the captured image. Furthermore, in the following description, for the purpose of convenience, the processing operation in step S831 is also referred to as “second behavior explanation processing.” In other words, the second behavior explanation processing is equivalent to processing for, while collectively targeting a series of image-captured persons included in the image, outputting generated text including an abnormal behavior determination reason regarding the behaviors of the series of image-captured persons.

It is desirable that, at the time of occurrence of an incident, rather than performing the first behavior explanation processing for each image-captured person and thus obtaining the behavior type and abnormal behavior determination reason thereof, the behavior explanation unit 205 performs the second behavior explanation processing to explain the status of an incident occurring in the entire acquired image. Therefore, in the third embodiment, the behavior explanation unit 205 is controlled to receive, as an input, instead of an individual image of each image-captured person involving abnormal behavior, a captured image or captured image sequence that has been acquired by the image capturing unit 201 and thus acquire an output that more correctly represents the overall situation. Moreover, the third embodiment is capable of obtaining a response with respect to a fixed data-length image input or image sequence input regardless of the number of detected image-captured persons and is, therefore, characterized to have responsiveness. Furthermore, in switching of the behavior explanation unit 205 from the first behavior explanation processing to the second behavior explanation processing, processing for changing a prompt (not illustrated) that is input to the behavior explanation unit 205 can be included.

An abnormal behavior determination reason that is output from the behavior explanation unit 205 when the second behavior explanation processing is performed is supplementarily described. In a case where the second behavior explanation processing is performed, because a situation about not an image-captured person but the entire input image is to be explained, for example, extracting the most abnormal point briefly is requested. As a specific example, it can be supposed that a prompt “based on the abnormality of behavior and the abnormality of a situation in an input image, explain an incident.” is input.

In the case of the example illustrated in FIG. 7, for example, the point “there is a person carrying a long object and people fleeing from that person.” can be recognized as the abnormality of behavior, and the point “although they are near a crosswalk, several people are ignoring the crosswalk.” can be recognized as the abnormality of a situation. Then, from these abnormalities, it can be concluded that the incident is “there is a possibility that the fleeing people are in a panic.”

The number of image-captured persons involving abnormal behavior in switching between the first behavior explanation processing and the second behavior explanation processing is supplementarily described. For example, while it is supposed that the threshold value for the number of image-captured persons involving abnormal behavior is “greater than or equal to X persons” or “greater than or equal to Y persons and greater than or equal to Z% of all of the image-captured persons included in a captured image,” the third embodiment is not limited to these.

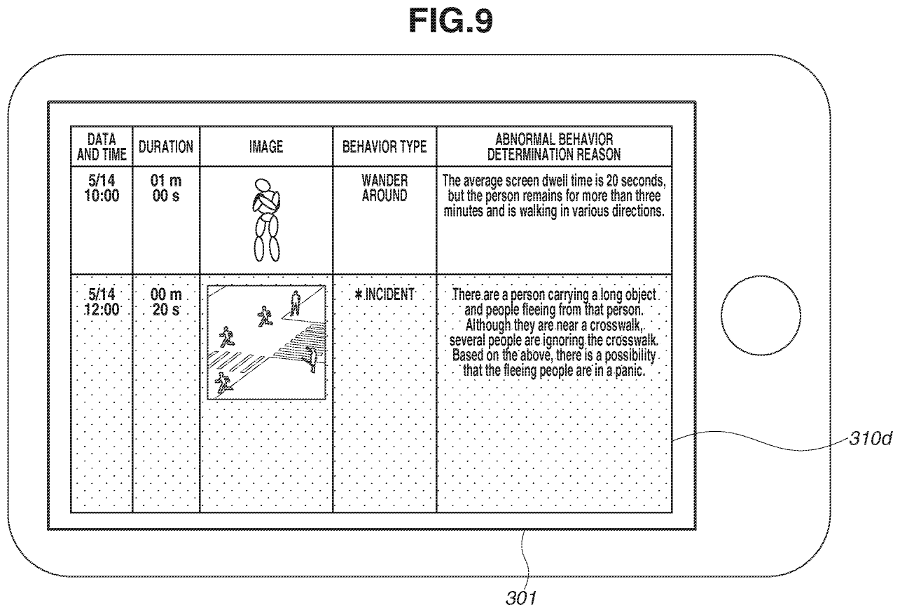

Processing operations related to control of a user interface (UI) included in the series of processing operations illustrated in FIG. 8 are described. FIG. 9 is a diagram illustrating an example of a UI that is displayed by the abnormal behavior display unit 206 of the abnormal behavior detection system according to the third embodiment.

In step S901, after the number of image-captured persons the behavior of whom has been determined to be abnormal is greater than zero, the abnormal behavior display unit 206 adds, to an abnormal behavior display unit UI 301, an abnormal behavior detection log 310d that is based on a result of detection of abnormal behavior.

Moreover, if, in step S830, it is determined that the number of image-captured persons the behavior of whom has been determined to be abnormal by the abnormal behavior detection unit 203 within a given fixed time exceeds the predetermined value, for example, the abnormal behavior display unit 206 updates the value of a behavior type in the abnormal behavior detection log with the behavior type acquired by the behavior explanation unit 205. Moreover, when, in step S831, an abnormal behavior determination reason of the captured image is acquired by the behavior explanation unit 205, then in step S903, the abnormal behavior display unit 206 updates an abnormal behavior determination reason in the abnormal behavior detection log.

Furthermore, in the example illustrated in FIG. 9, in a case where, as shown in the abnormal behavior detection log 310d, the second behavior explanation processing has been performed, an abnormal behavior detection log is output for every incident. In other words, in this case, a determination as to whether behavior is abnormal while collectively targeting a series of image-captured persons included in the image is performed, and, if the result of determination indicates abnormality, the log of the behavior of the series of image-captured persons is output as an abnormal behavior detection log. On the other hand, in a case where the first behavior explanation processing has been performed, as with the above-described first and second embodiments, the behavior type and the abnormal behavior determination reason are output as an abnormal behavior detection log individually for every piece of behavior data (in other words, individually for every image-captured person).

As described above, according to the abnormal behavior detection system in the third embodiment, it is possible to determine, with regard to an optional image-captured person, whether the behavior of the image-captured person is abnormal, identify a behavior type of the image-captured person, and then notify the user of a result of identification of the behavior type. Moreover, even at the time of occurrence of an incident in which a great number of abnormal behaviors are detected at one time, switching the processing to be performed by the behavior explanation unit 205 enables ensuring responsiveness and explainability.

### Other Embodiments

While various embodiments have been described above in detail, the present disclosure can be embodied as, for example, a system, an apparatus, a method, a program, and a recording medium (storage medium). Specifically, the present disclosure can be applied to a system composed of a plurality of pieces of equipment (for example, a host computer, interface equipment, an image capturing apparatus, and a web application), or it can be applied to an apparatus composed of one piece of equipment.

Moreover, naturally, the present disclosure can be attained by performing the following processing. Thus, the processing supplies, to a system or apparatus, a recording medium (or a storage medium) in which program code (computer program) of software which implements the functions of the above-described embodiments is recorded or stored. Such a storage medium is, naturally, a computer-readable storage medium. Then, a computer (or a CPU or a micro processing unit (MPU)) of the system or apparatus reads out and executes the program code stored in the storage medium (recording medium). In this case, the program code itself read out from the storage medium (recording medium) implements the functions of the above-described embodiments, and the storage medium (recording medium) in which the program code is stored or recorded constitutes the present disclosure.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to an aspect of the present disclosure, it is possible to provide a contrivance concerning detection of abnormal behavior in which both responsiveness and explainability are satisfied in a more favorable fashion.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-076853 filed May 2, 2025, which is hereby incorporated by reference herein in its entirety.

What is claimed is:

1. An information processing system comprising:
at least one processor; and
at least one memory having stored therein instructions which, when executed by the at least one processor, cause the information processing system at least to:
acquire behavior data concerning behavior of an image capturing target included in an image acquired by an image capturing unit;
determine whether the behavior of the image capturing target included in the behavior data is normal or abnormal; and
output a behavior type and an abnormal behavior determination reason corresponding to the image capturing target the behavior of which has been determined to be abnormal,
wherein output processing for the behavior type is performed prior to output processing for the abnormal behavior determination reason.

2. The information processing system according to claim 1, wherein the instructions further cause the information processing system to:
perform control to display a behavior log corresponding to the behavior data in which the behavior of the image capturing target has been determined to be abnormal;
update information indicating a behavior type of the behavior included in the behavior log, which has been determined to be abnormal, after completion of the output processing for the behavior type of the behavior; and
update information indicating an abnormal behavior determination reason of the behavior included in the behavior log, which has been determined to be abnormal, after completion of the output processing for the abnormal behavior determination reason of the behavior.

3. The information processing system according to claim 1, wherein the behavior data includes one or more of an image of the image capturing target, an image sequence of the image capturing target, a posture estimation result of the image capturing target, a posture estimation result sequence of the image capturing target, coordinate information in the image concerning the image capturing target, or a coordinate information sequence in the image concerning the image capturing target.

4. The information processing system according to claim 1, wherein the instructions further cause the information processing system to:
output a statement for speaking to the image capturing target the behavior of which has been determined to be abnormal,
wherein the output processing for the behavior type is performed prior to output processing for the statement for speaking to the image capturing target.

5. The information processing system according to claim 1, wherein the instructions further cause the information processing system to:
in a case where the behavior of the image capturing target has been determined to be abnormal, output a notification destination selected from among a preliminarily registered plurality of notification destinations,
wherein the output processing for the behavior type is performed prior to output processing for the notification destination.

6. An information processing system comprising:
at least one processor; and
at least one memory having stored therein instructions which, when executed by the at least one processor, cause the information processing system at least to:
acquire behavior data concerning behavior of an image capturing target included in an image acquired by an image capturing unit;
make a determination as to whether the behavior of the image capturing target included in the behavior data is normal or abnormal, and output a result of the determination and a first likelihood concerning the determination;
make a classification about the image capturing target the behavior of which has been determined to be abnormal concerning which of a plurality of candidates for preliminarily defined behavior types a type of behavior of the image capturing target included in the behavior data corresponds to, and output a result of the classification and a second likelihood, the second likelihood being an estimation likelihood of a candidate for the classified behavior type;
output a behavior type and an abnormal behavior determination reason corresponding to the image capturing target the behavior of which has been determined to be abnormal and the second likelihood of which is less than or equal to a second predetermined value; and
generate additional training data with use of the behavior data and the behavior type in which the first likelihood exceeds a first predetermined value and the second likelihood is less than or equal to the second predetermined value, and perform additional learning with use of the additional training data,
wherein output processing for the behavior type is performed prior to output processing for the abnormal behavior determination reason.

7. The information processing system according to claim 6, wherein the instructions further cause the information processing system to:
perform control to display a behavior log corresponding to the behavior data in which the behavior of the image capturing target has been determined to be abnormal;
update information indicating a behavior type of the behavior included in the behavior log, which has been determined to be abnormal, after completion of the output processing for the behavior type of the behavior; and
update information indicating an abnormal behavior determination reason of the behavior included in the behavior log, which has been determined to be abnormal, after completion of the output processing for the abnormal behavior determination reason of the behavior.

8. An information processing system comprising:
at least one processor; and
at least one memory having stored therein instructions which, when executed by the at least one processor, cause the information processing system at least to:
acquire behavior data concerning behavior of one or a plurality of image capturing targets included in an image acquired by an image capturing unit;
determine whether the behavior of each of the one or the plurality of image capturing targets included in the behavior data is normal or abnormal;
in a case where the behavior of at least one image capturing target included in the behavior data has been determined to be abnormal, output an abnormal behavior determination reason concerning the at least one image capturing target;
depending on a number of image capturing targets included in the behavior data for which the behavior has been determined to be abnormal, perform one of first behavior explanation processing, which outputs a behavior type and an abnormal behavior determination reason for each image capturing target included in the behavior data, or second behavior explanation processing, which, while collectively targeting a series of image capturing targets included in the image in which the behavior data has been acquired, outputs an abnormal behavior determination reason regarding behaviors of the series of image capturing targets; and
when performing the first behavior explanation processing, perform output processing for the behavior type prior to output processing for the abnormal behavior determination reason.

9. The information processing system according to claim 8, wherein the instructions further cause the information processing system to:
in a case where the behavior of at least one image capturing target has been determined to be abnormal, perform control to display a behavior log of the behavior that has been determined to be abnormal;
when having performed the first behavior explanation processing, update information indicating a behavior type of the behavior included in the behavior log, which has been determined to be abnormal, after completion of the output processing for the behavior type of the behavior, and update information indicating an abnormal behavior determination reason of the behavior included in the behavior log, which has been determined to be abnormal, after completion of the output processing for the abnormal behavior determination reason of the behavior; and
when having performed the second behavior explanation processing, update information indicating an abnormal behavior determination reason of the behavior included in the behavior log, which has been determined to be abnormal, after completion of the output processing for the abnormal behavior determination reason of the behavior.

10. An information processing system comprising:
at least one processor; and
at least one memory having stored therein instructions which, when executed by the at least one processor, cause the information processing system at least to:
acquire behavior data concerning behavior of an image capturing target included in an image acquired by an image capturing unit;
determine whether the behavior of the image capturing target included in the behavior data is normal or abnormal; and
output a behavior type and an abnormal behavior determination reason corresponding to the image capturing target the behavior of which has been determined to be abnormal.

11. A control method for an information processing system, the control method comprising:
acquiring behavior data concerning behavior of an image capturing target included in an image acquired by an image capturing unit;
determining whether the behavior of the image capturing target included in the behavior data is normal or abnormal; and
outputting a behavior type and an abnormal behavior determination reason corresponding to the image capturing target the behavior of which has been determined to be abnormal,
wherein output processing for the behavior type is performed prior to output processing for the abnormal behavior determination reason.

12. A non-transitory computer-readable storage medium storing computer-executable instructions that, when executed by a computer, cause the computer to function as an information processing system comprising:
an acquisition unit configured to acquire behavior data concerning behavior of an image capturing target included in an image acquired by an image capturing unit;
a determination unit configured to determine whether the behavior of the image capturing target included in the behavior data is normal or abnormal; and
an output unit configured to output a behavior type and an abnormal behavior determination reason corresponding to the image capturing target the behavior of which has been determined to be abnormal,
wherein output processing for the behavior type is performed prior to output processing for the abnormal behavior determination reason.
